(19) United States
(12) Patent Application Publication
(10) Pub. No.: US 2009/0327621 A1
(43) Pub. Date: Dec. 31, 2009

(54) VIRTUAL MEMORY COMPACTION AND COMPRESSION USING COLLABORATION BETWEEN A VIRTUAL MEMORY MANAGER AND A MEMORY MANAGER

(75) Inventors: Gabriel Kliot, Haifa (IL); Erez Petrank, Redmond, WA (US); Bjame Steensgaard, Bothell, WA (US)

Correspondence Address: DOMINIC S. LINDAUER;LEE & HAYES, PLLC, SUITE 500, 421 W. RIVERSIDE AVENUE, SPOKANE, WA, 99201, US

(73) Assignee: Microsoft Corporation, Redmond, WA (US)

(21) Appl. No.: 12/163,777

(22) Filed: Jun. 27, 2008

(51) Int. Cl. G06F 12/02

(52) U.S. Cl. 711/154; 711/173; 711/E12.002

(57) ABSTRACT

Enhanced performance and functionality in virtual memory is possible when a virtual memory manager and a memory manager are configured to collaborate.

### BACKGROUND

A virtual memory mechanism is an addressing scheme implemented in hardware or software or both that allows non-contiguous memory to be addressed as if it is contiguous or vice versa. A virtual memory mechanism maps virtual memory pages to physical memory (for example, in random access memory (RAM)) frames. Virtual memory tables are used to record the mapping of virtual memory pages to physical memory frames.

When the operating system (particularly, the kernel) encounters a shortage in physical memory, its virtual memory manager picks a number of virtual memory pages to be swapped out to the swap area in the stable storage (for example, hard disk), thus releasing the physical memory frames occupied by these pages. The decision of which pages to swap out is made by the swapping algorithm and, for example, may be based on the Least Recently Used (LRU)/Least Frequently Used (LFU) heuristic.

When a page is chosen to be swapped out, the virtual memory manager protects this page by setting a special flag in the virtual memory table, and the contents of the page may then be swapped out to slower stable storage. Upon an application's access to any address residing on this virtual memory page, the hardware memory management unit triggers a page fault exception. The virtual memory manager handles the page fault exception by pausing the application process and paging in the memory page from the stable storage. Upon completion of the page transfer, the virtual memory manager resumes the application which may then successfully complete its access to the virtual memory page.

### SUMMARY

A bidirectional communication pathway is established between the virtual memory manager (and associated paging system) in the operating system and the memory manager of programs running on the device, allowing for interaction, collaboration and increased functionality.

Current swapping algorithms typically use the LRU/LFU heuristic looking at frequency of use. By also taking into account the size and quantity of live objects on the pages from information provided by the memory manager in determining what to swap, overall performance can be affected.

Rather than swapping entire pages out to stable memory, allocated regions of the page (denoted “live objects”) which do not necessarily occupy a full page, may be compacted. Compacting may involve copying a live object which is smaller than a page into a single page with other live objects. This compaction keeps live objects in physical memory rather than swapping them to slower stable memory. By keeping live objects in physical memory, faster access times and more effective use of virtual memory resources are possible. To further maximize use of scarce physical memory, compression can also be used.

Even where stable memory is not present, a virtual increase in the memory space is possible. Live objects may be compacted or compressed (or both) in memory, thus virtually increasing the available memory space

Additionally, to alleviate the costs involved with un-compaction, application pointers may be updated to refer to the new addresses of the live objects in the compacted pages. The pointer updates may be performed by a runtime system, or by a similar process. In the presence of a garbage collector, the pointer updates may conveniently be updated during garbage collection.

This summary is provided to introduce the subject matter of virtual memory compaction and compression using collaboration between a virtual memory manager and a memory manager, which is described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of an exemplary collaboration engine.

FIG. 2 is a diagram of an exemplary computing system showing a collaboration engine and components.

FIG. 3 is a diagram of an alternative implementation of the computing system shown in FIG. 2.

FIG. 4 is a flow diagram showing how the collaboration engine facilitates collaboration between the memory manager and the virtual memory manager. FIG. 5 is a flow diagram showing overall functionality of the collaboration engine and the update of application pointers.

FIG. 6 expands upon one possible implementation of the compaction method described with reference to block 412 in FIG. 4.

FIG. 7 expands upon one possible implementation of the method described with reference to block 506 in FIG. 5 for updating application pointers during garbage collection.

FIGS. 8A, 8B, and 8C are diagrams of exemplary configurations in which compacted pages and their page mapping information may be stored.

FIG. 9 is an exemplary diagram showing memory pages, labeled 0-7, before and after compaction of live objects.

FIG. 10 is a diagram of live objects in virtual memory pages being subjected to compression.

FIG. 11 shows a diagram of live objects in virtual memory pages being subjected to compaction and compression.

FIG. 12 is a diagram of live objects in virtual memory pages being subjected to compaction and the use of an in-memory virtual swap space.

FIG. 13 illustrates the use of virtual memory by the collaboration engine using data gained from applications to adjust paging.

FIG. 14 is a diagram of the movement of the live objects in virtual memory pages shown in FIG. 13.

FIG. 15 shows an exemplary computing system suitable as an environment for practicing aspects of the subject matter, for example to host an exemplary collaboration engine.

### DETAILED DESCRIPTION

### Overview

This disclosure describes a collaboration engine to facilitate communication between the memory manager and the virtual memory system in a computer resulting in more effective use of memory resources and improved performance. Additionally, such collaboration facilitates improved compression and compaction of pages in virtual memory. Compaction and compression as used herein also include their counterpart functions of un-compaction and de-compression unless specifically noted.

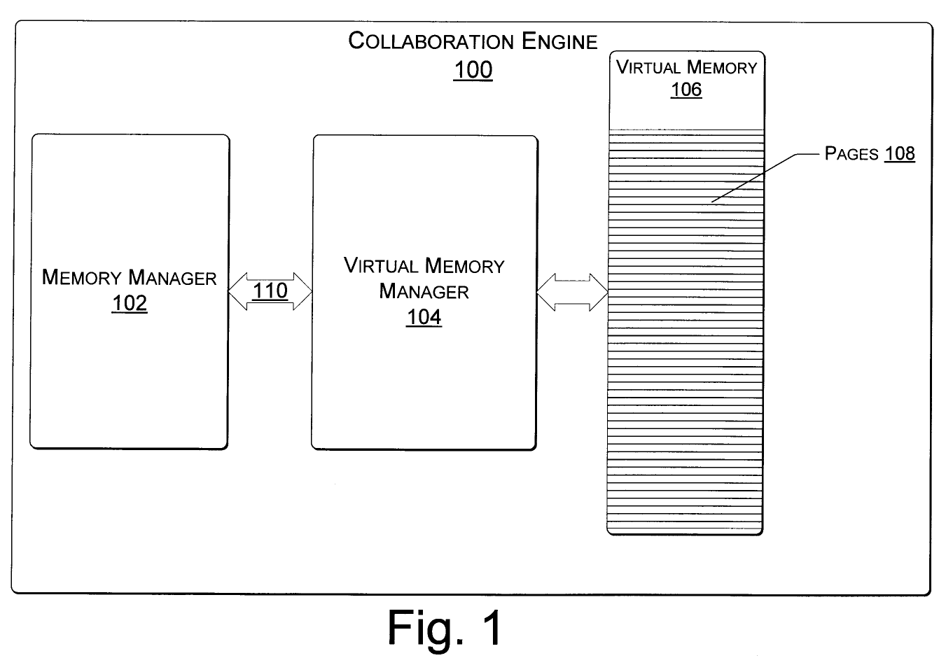

FIG. 1 is an exemplary diagram of a collaboration engine 100. The collaboration engine 100 is comprised of a memory manager 102, a virtual memory manager 104 and a virtual memory 106. The virtual memory 106 is divided into pages 108 for storing live objects. The collaboration engine facilitates bidirectional communication 110 between the memory manager 102 and the virtual memory manager 104. Facilitating communication 110 between the memory manager 102 and the virtual memory manager 104 by using a collaboration engine 100 allows the following benefits to be realized.

### Operation of the Exemplary Collaboration Engine

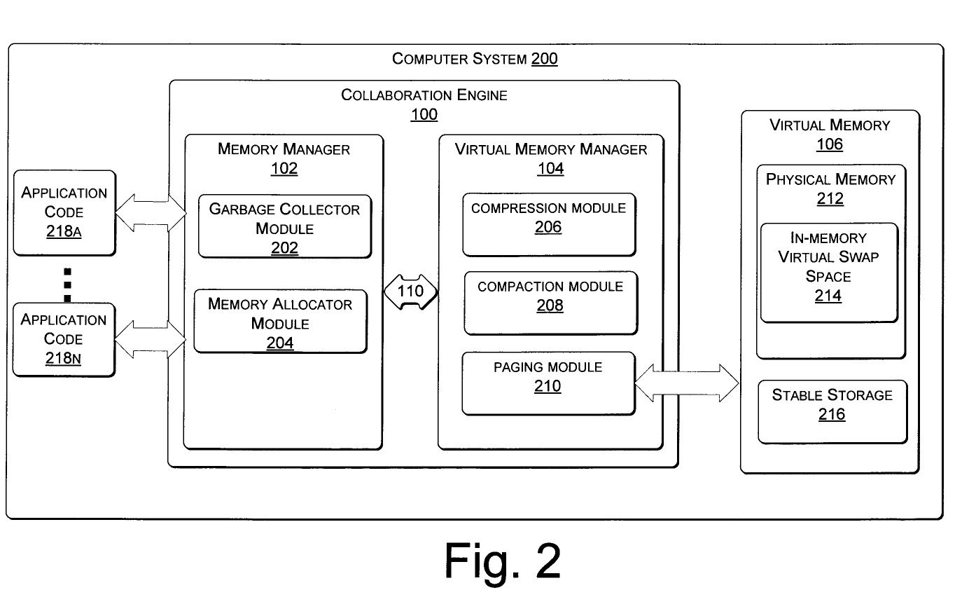

FIG. 2 is a diagram of an exemplary computing system showing a collaboration engine and its components in greater detail for descriptive purposes. Many other arrangements of the components of an exemplary collaboration engine 100 are possible within the scope of the subject matter. Such an exemplary collaboration engine 100 can be executed in hardware, software, or combinations of hardware, software, firmware, etc.

We now turn to the collaboration engine 100 inside computer system 200 in more depth. The memory manager 102 may contain, for example, a garbage collector module 202 and a memory allocator module 204. The virtual memory manager 104 may contain a compression module 206, a compaction module 208, and a paging module 210. The memory manager 102 is in bidirectional communication 110 with the virtual memory manager 104. The paging module 210 is in communication with the virtual memory 106. Virtual memory 106 may contain physical memory 212 as well as stable storage 216. The physical memory 212 may also contain in-memory virtual swap space 214. Physical memory 212 may comprise random access memory (RAM), non-volatile RAM, static RAM, etc. Stable storage 216 may comprise hard disk drive, optical storage, magnetic storage, etc. The virtual memory 106 is operatively coupled to communicate with the collaboration engine 100, typically (but not limited to) to the paging module 210 in the virtual memory manager 104.

Application code 218A through 218N are operatively coupled with the memory manager 102 (or other parts of the collaboration engine 100) and can communicate bidirectionally.

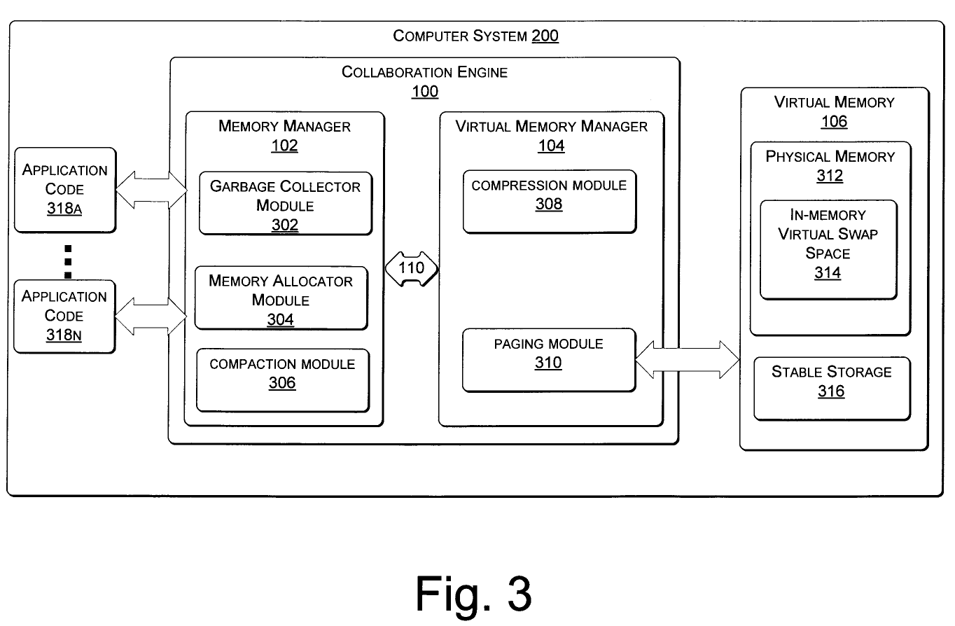

FIG. 3 is a diagram of an alternative implementation of the computing system shown in FIG. 2. In this alternative implementation, the compaction module 306 is located within the memory manager 102. Other alternatives include the compression module within memory manager 102 as well. Furthermore, compaction modules or compression modules or both may be present in memory manager 102 and simultaneously in virtual memory manager 104.

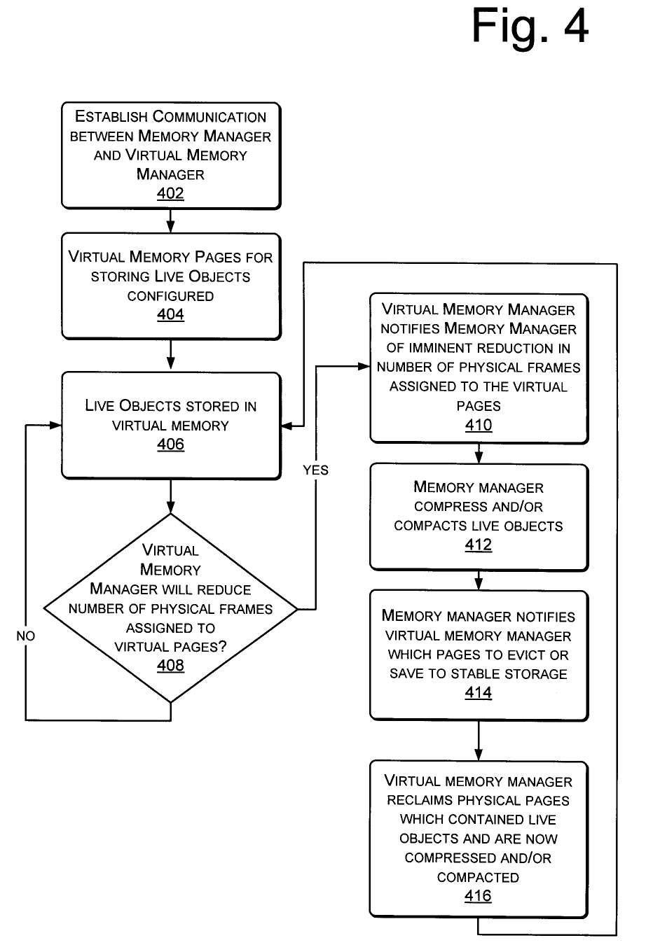

FIG. 4 is a flow diagram showing how the collaboration engine facilitates collaboration between the memory manager and the virtual memory manager. For simplicity, the process will be described with reference to the computer system 200 described above with reference to FIGS. 2 through 3.

Although specific details of exemplary methods are described with regard to FIG. 4 and other flow diagrams presented herein, it should be understood that certain acts shown in the figures need not be performed in the order described, and may be modified, and/or may be omitted entirely, depending on the circumstances. Moreover, the acts described may be implemented by a computer, processor or other computing device based on instructions stored on one or more computer-readable media. The computer-readable media can be any available media that can be accessed by a computing device to implement the instructions stored thereon.

At 402, communication is established between the memory manager and the virtual memory manager. This may involve a contracting solution or a callback solution, as discussed in more depth below.

At 404, virtual memory pages 108 for storing live objects within virtual memory 106 are then configured.

At 406, live objects are stored in virtual memory.

At 408, a determination is made whether the virtual memory manager needs to reduce the number of physical frames assigned to virtual pages. When no reduction takes place, no action is taken.

At 410, a reduction in the number of physical frames assigned to virtual pages is imminent, and the virtual memory manager notifies the memory manager.

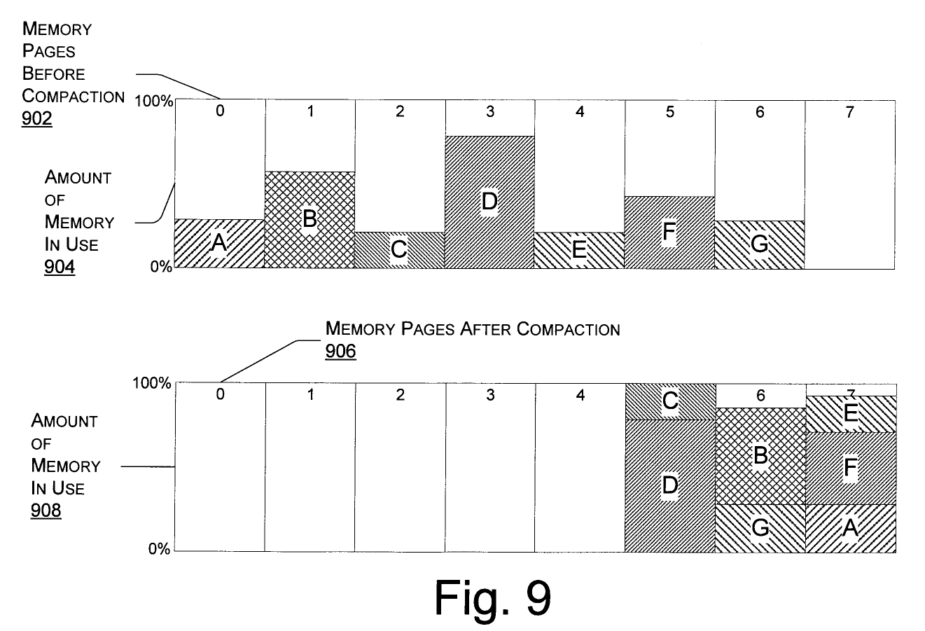

At 412, the memory manager may compress, or compact, or both, live objects. Compaction or compression or both may also be performed by the virtual memory manager, or by a combination of memory manager and virtual memory manager. When the objects are compacted they are copied from one place to another in memory. Compression, compaction, and the combination are discussed in more detail below with regards to FIGS. 9-11.

At 414, the memory manager notifies the virtual memory manager which pages to discard and which pages or parts of pages to evict or to save to stable storage, thus freeing additional pages for use. The contents of physical memory frames corresponding to virtual memory pages that used to contain live objects that have been compacted or compressed can be discarded because the contents can be reconstructed when needed. For physical memory frames that are only sparsely populated with live objects, only the content of the used parts needs to be swapped to stable storage, as the content of the unused parts do not need to be reconstructed if the virtual memory page is accessed in the future.

At 416, the virtual memory manager may now reclaim physical pages which contained live objects now compressed or compacted, or both. Given that these objects are stored in another location in compressed form or compacted form, or a combination form, they may be reclaimed.

FIG. 5 is a flow diagram showing how the compaction method of the collaboration engine can be augmented with update of application pointers. For simplicity, the process will be described with reference to the computer system 200 described above with reference to FIGS. 2 through 4.

At 502, the live objects to be temporarily removed from a virtual memory page are determined. Based on the results, as described above in 412, the objects may be compacted or compressed or both. After that is done, the page with compacted objects may then be swapped out to stable storage, if such is available. Such a swap to stable storage is independent of compression or compaction or both.

The location to which live objects may be swapped includes physical memory 212 (either physical memory 212 or in-memory virtual swap space 214) or stable storage 216. This may occur after communicating with the memory manager 102 to learn the size and likelihood of use of the live object.

The memory manager 102 may gain this information from the garbage collector module's 202 recent trace of live objects in the heap (in the case of managed applications) or (for unmanaged applications) from the user space memory allocator module 204, which knows which parts of the page were allocated by the application 218A-218N.

With this information, a heuristic for deciding which pages to swap can balance between the two factors of recent (or frequent) use and least occupied space. Other heuristics may be used including, but not limited to, looking among all pages not recently (or not frequently) used and picking the one with the least amount of allocated objects.

At 504, the paging module 210 may then swap out virtual memory pages containing live objects as determined previously. The paging module may base swap decisions on a live object's size and likelihood of use of the live object, based on information from the memory allocator.

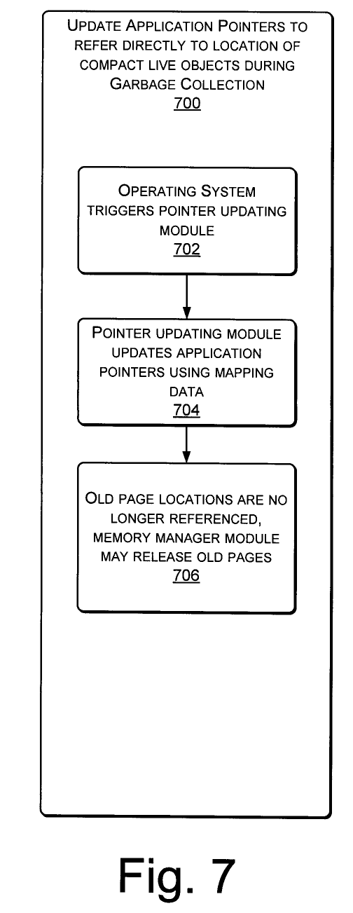

At 506, application pointers are updated to refer directly to the location of compacted live objects during garbage collection, which is addressed in more depth in FIG. 7. The compaction step involves copying the representation of a live object from one memory location to another memory location. The memory manager could choose to make the program use the new memory location to represent the live object instead of using the old memory location. Continuing to use the old memory location for the live object requires the memory manager to reconstruct the contents of the old memory location upon access to the live object. By instead having the program use the new memory location for the live object, the memory manager is released from the obligation to reconstruct the contents of the original memory location upon access of the live object. The change to have the program use the new memory location for the live object requires that the program state be updated to recognize the new memory location for the live object. This can be achieved by changing all pointers to the old memory location to instead point to the new memory location.

For some runtime systems, the addition of “forwarding pointers” from the old location to the new location can be used to ensure that the program uses the new memory location even while some program pointers may not have been updated. The process of updating pointers from an old memory location to a new memory location may be incorporated into the process of garbage collection, or it may be performed as a separate process.

### Compaction

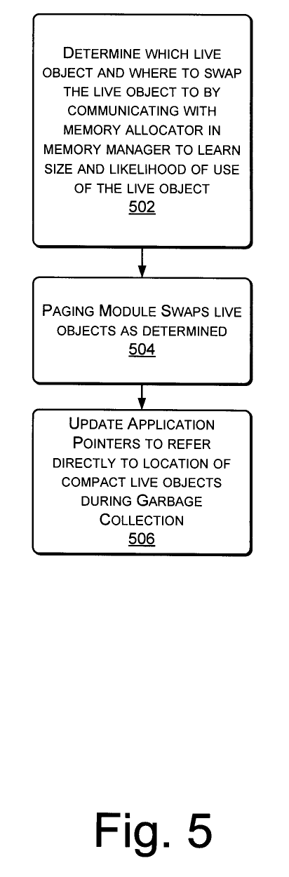

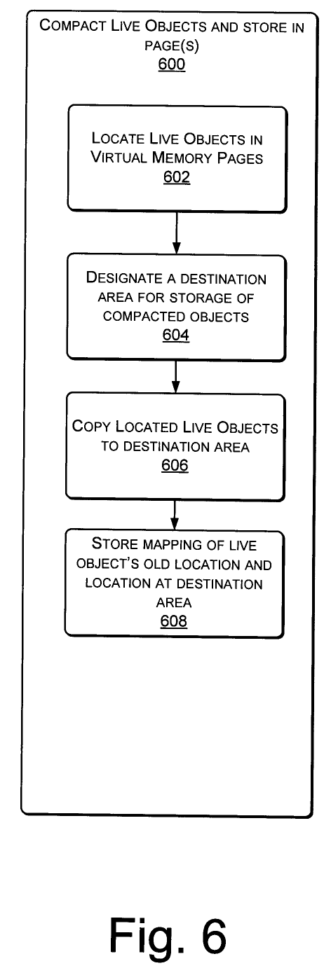

FIG. 6 expands upon one possible implementation of the compaction method described with reference to block 412 in FIG. 4. The act of compaction comprises copying live objects smaller than a page so they share pages with other live objects 600

At 602, live objects within virtual memory pages are located.

At 604, a destination area for storage of compacted objects is designated. The destination area for these objects may be a specially designated memory space, or any free memory location that can later be found when the objects are needed again. The destination area may be an otherwise unused page. Alternatively, the destination area may be the unused portions of a page that already contains live objects or data from prior compression and compaction efforts.

At 606, these located live objects are then copied to the destination area. Copying only live objects to share pages with other live objects frees the pages which originally contained the live objects for use or eviction. By compacting objects away from sparsely populated pages, a net reduction may be achieved in the total number of physical memory frames needed by the program.

At 608, a mapping of the live object's old location and the new location on the compacted page is stored.

FIG. 7 expands upon one possible implementation of the method described with reference to block 506 in FIG. 5 for updating application pointers during garbage collection 700. Once compacted, un-compaction can be costly. At 700, the cost of un-compaction in managed applications (where automatic memory management is used) is alleviated. As a substitute for un-compaction, application pointers may be updated to point to the new locations of objects moved by compaction.

At 702, the operating system may activate a pointer updating module of the runtime system. The pointer updating module may be incorporated into the garbage collector module of the runtime system, or it may be an independent component of the runtime system.

At 704, the pointer updating module then updates the application pointers. The application pointers to be updated may be identified using pointer map information also used by a garbage collection module. This update is similar to pointer updating for a standard garbage collection compaction, except that the compaction is done on a page based granularity and the pointer update does not need to complete on time. If the original data is accessed before pointers fix-up is executed, it is still possible to un-compact the data and restore it into the original virtual address space. While it is convenient to incorporate the pointer updating functionality into a garbage collector, other embodiments are possible. For example, the pointer updating module may be component of the runtime system that is completely separate from any garbage collection module.

For runtime systems where forwarding pointers from the old object location to the new object location are used temporarily during object relocation, when the object is being moved to the compacted location, only the forwarding pointer component of the old object location needs to be restored if the old object location is accessed.

When the pointers are updated, the application no longer holds pointers to the old objects, and thus there is no need to un-compact those pages anymore. This aids un-compaction because rather than un-compacting an object by copying it to a new page upon demand, the application may directly access the live object.

At 706, the old page locations are no longer referenced and thus the memory manager module may release those pages.

One implementation assumes a special memory space for the compacted area and a memory region within that special memory space that corresponds to the original page. In this case, the mapping may consist of any suitable structure including, but not limited to, two words and two bytes (original address, new address, original size, and compacted size) for any allocated space (object) that is moved. An alternative implementation performs compaction by first identifying the parts of the page that are occupied, and then copying the contents of these smaller memory areas into unoccupied parts of pages that are not currently destined to be swapped out. In this case, the collaboration with the memory manager or garbage collector may allow fine-grained interleaving of memory areas actively used by the running program and memory areas used for storage of the contents of compacted (swapped out) pages.

The compaction may be executed at some time before the page is swapped-out. Options for this execution include a contracting solution, callback solution, or other suitable means.

In the contracting solution, the virtual memory manager does the compaction itself, given information from the memory manager about which objects are live. The memory manager library will maintain the mapping of all allocated regions of this process. This mapping may be stored in a memory region whose address will be delivered to the virtual memory manager via an initial system call. The virtual memory manager can then simply access this mapping region when needed. The virtual memory manager can then use this mapping to perform the compaction.

Another option to compact is to not change the memory allocation library itself, but change the user program, by linking through the collaboration engine. Memory allocators (e.g., GNU glibc malloc) allow one to define hook functions as part of user program. Those hooks change the regular allocation function. Inside this hook the collaboration engine can record allocation requests such as calls for the regular allocation method, and before returning to the program record the allocated address and the size, as well as all free requests.

In a callback solution, the memory allocator performs the compaction. The virtual memory manager is given the entry of callback routines that decide which pages to compact, perform a compaction, and perform uncompaction. The virtual memory manager may use a callback to indicate to the memory manager that it intends to reclaim a number of physical memory frames in the near future. The memory manager can then decide if it can clear memory pages by compaction or compression or if it will have to let the virtual memory manager reclaim the pages by means of swapping.

Regardless of whether a contracting or callback solution is used, the compacted pages and mapping information need to temporarily be stored somewhere. The information may be stored in virtual memory that may either be backed by physical memory or be swapped out. The information may be made obsolete and subsequently deleted as a consequence of decompression, uncompaction, or pointer fixups.

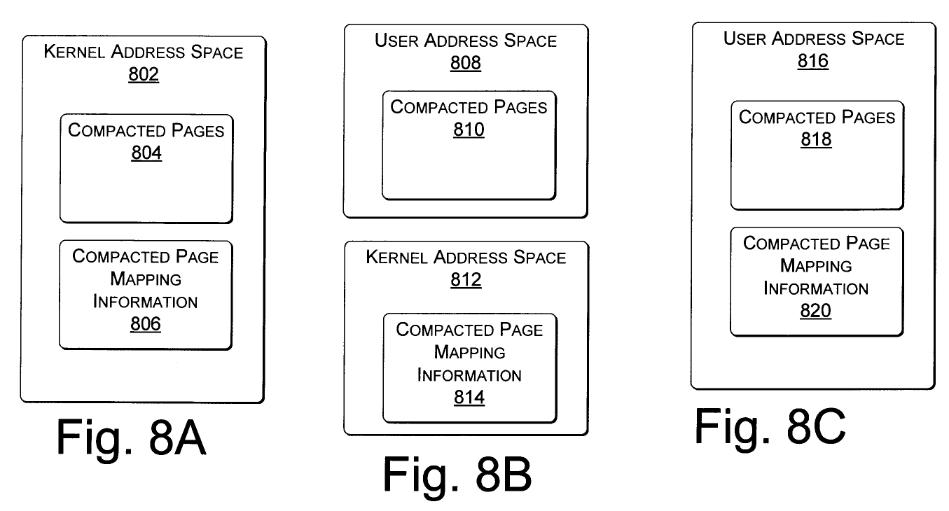

FIGS. 8A, 8B, and 8C are diagrams of exemplary configurations in which compacted pages and their page mapping information may be stored. When compaction takes place, compacted pages and their associated mapping information must be stored.

As shown in FIG. 8A, kernel address space 802 may be used to store the compacted pages 804 and compacted page mapping information 806. This eases the implementation of this method and allows the kernel to store data from different processes on the same compacted area. However in this approach the kernel must execute the compaction itself.

Alternatively, FIG. 8B shows an exemplary configuration in which user address space 808 is used to store compacted pages 810, while kernel address space 812 is used to store the compacted page mapping information 814. In this case, each process will have its own set of compaction pages.

FIG. 8C shows another exemplary configuration in which the user address space 816 is used to store compacted pages 818 and compacted page mapping information 820. This will allow the memory allocator to perform the compaction/un-compaction.

FIG. 9 is an exemplary diagram showing memory pages, labeled 0-7, before and after compaction of live objects. For example, memory pages 0-7 before compaction 902 are illustrated with live objects A-G indicated, their varying height indicating the relative size 904. Prior to compaction, the data is distributed throughout the memory pages, with only page 7 being unused. As shown in 906, after compaction memory pages 0-4 are now unused and pages 5-7 now contain the compacted objects. Objects which are compacted may be spread across multiple pages, share pages with other compacted objects, or share pages with non-compacted objects. Furthermore, a mapping between the data blocks on the original page and their new location on the compressed page can be maintained to facilitate operation.

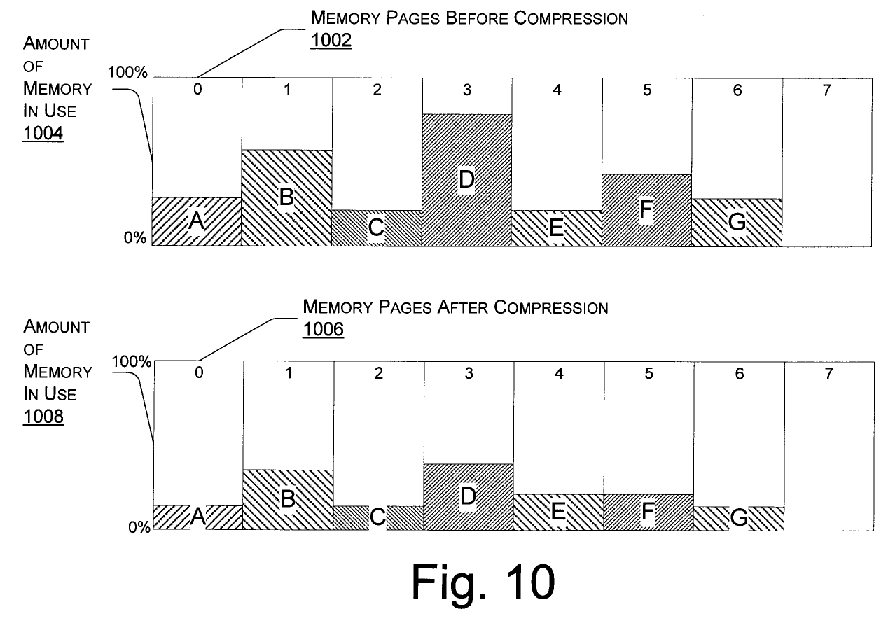

FIG. 10 is a diagram of live objects in virtual memory pages being subjected to compression. In addition, or as an alternative, to compaction (described previously), compression can be used to reduce the size of the live objects to free up memory pages. A variety of well known compression methods may be used including, but not limited to, LZW, run-length encoding, Huffman coding, etc. Alternatively, custom compression methods that utilize information available to the memory manager may be used, including, but not limited to, translating strings from Unicode format to UTF-8 format, representing pointers to small domains of objects as indices into lookup tables, etc. A mapping between the data blocks on the original page and their new location on the compressed page can be maintained to facilitate operation. FIG. 10 shows memory pages 0-7 before compression 1002 and after compression 1006. Live objects A-G are indicated, their varying height indicating the relative size before compression 1004 and after compression 1008. As shown in 1006, after compression of objects A-G in memory pages 0-6, the relative amount of memory in use by the objects has been reduced after compression 1008.

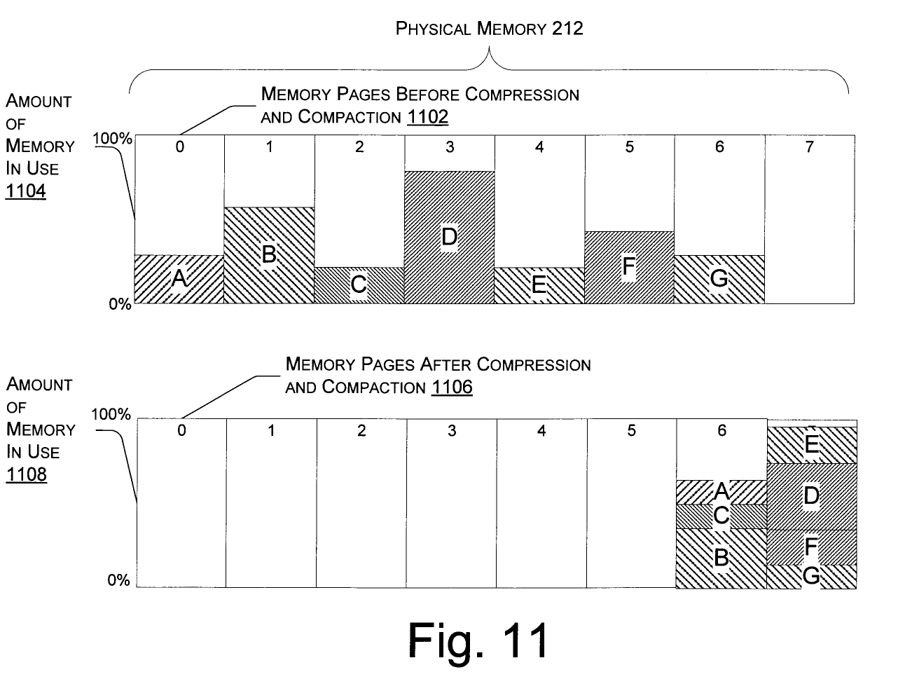

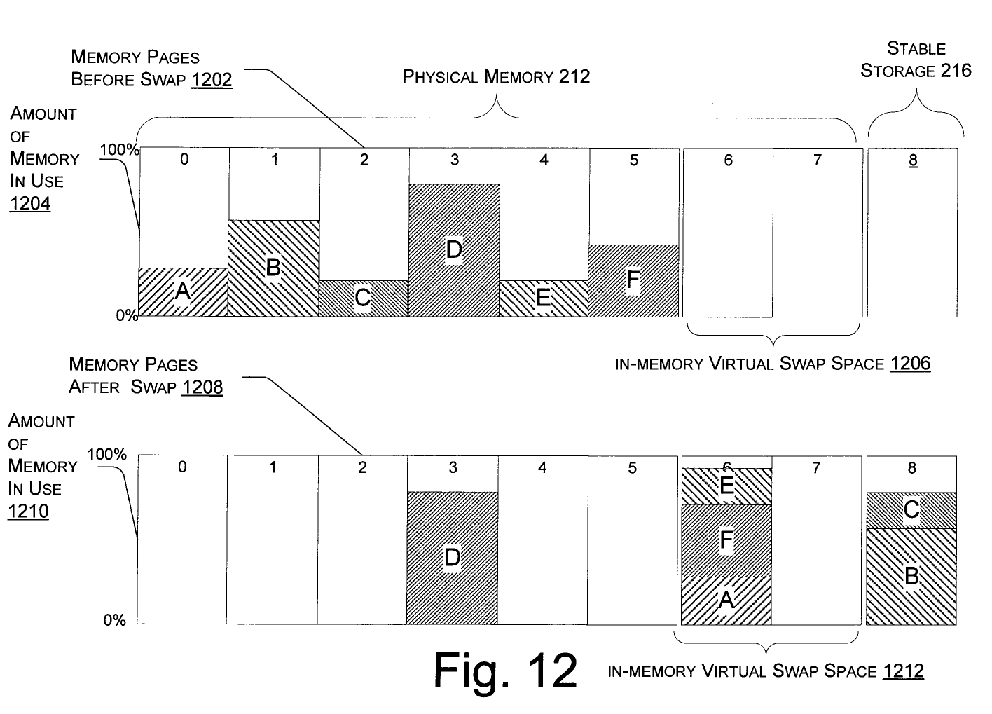

FIG. 11 shows a diagram of live objects in virtual memory pages being subjected to compaction and compression. Memory pages 0-7 before compaction 1102 are illustrated with live objects A-G indicated. The varying height of the live objects indicates their relative size in memory 1104. Prior to compression and compaction, the data is distributed throughout the memory pages with only page 7 being unused.

As shown in 1106 after compression and compaction, memory pages 0-5 are now unused, with live objects A-G in pages 6 and 7. Compared to FIG. 9 (compaction alone) the combined use of compaction and compression results in an additional unused page, and compared to FIG. 10 (compression alone) there are 5 additional unused pages. If desired, objects could have also been stored in stable storage or any combination of stable storage and physical memory. Furthermore, objects which are compressed or compacted or both may be spread across multiple pages, or share pages with non-compacted/non-compressed objects.

FIG. 12 is a diagram of live objects in virtual memory pages being subjected to compaction and the use of an in-memory virtual swap space, as a result of the collaboration between the virtual memory manager and memory manager. Memory pages 0-7 before compaction and use of in-memory virtual swap space 1202 are illustrated with live objects A-F indicated. The varying height of the live objects indicates their relative size in memory 1204. An in-memory virtual swap space 1206 has been designated in physical memory 212.

The benefits of collaboration between the memory manager and virtual memory manager are now illustrated. Suppose the virtual memory manager indicates to the memory manager a need to reclaim four pages in physical memory 212.

Where six memory pages were initially in use (pages 0-5), after collaboration between the memory manager and virtual memory manager, at 1208 memory pages have been swapped, objects E, F, and A are compacted and placed in in-memory virtual swap space 1212. Live objects C and B have been moved to stable storage 216. After objects are compacted, and possibly compressed, the original page is protected in the virtual memory table as if being swapped out. This is done even though it was not swapped out to a stable storage 216 swap device. The pages that contained live objects C and B were not necessarily directly swapped out to stable storage, but the objects may instead have been compacted into “in-memory virtual swap space” 1206, and the compacted page subsequently swapped out to stable storage. The compacted object's frame is released by putting it on the list of free pages. Sufficient information is recorded to allow the compacted page to be found whenever it is required to be paged back in. One implementation is to record an index to the mapping of the moved space in the virtual memory table. As a result of the collaboration, four physical memory frames are now available for use.

When a page fault occurs as a result of an attempted access of a virtual memory page that was swapped out according to this method (upon an application's read/write to such a swapped out virtual memory page), the page cannot simply be swapped in from the stable storage. Instead, the index to the mapping data structure is followed to find the compacted page, possibly uncompress the data if it was earlier compressed, and copy the data from its compacted location back into a newly allocated frame (with the same offsets as it was stored before). If the compacted page has been swapped to stable storage, the data on the compacted page must be retrieved from stable storage in order to restore the contents of the original page. After restoring the data into this new physical frame, this frame is associated with the appropriate virtual memory page and the application can resume and access the data in a regular fashion. Alternatively, the association of a frame with the appropriate virtual memory page may be done before the data is being restored to its original location in virtual memory. An important benefit is that paging-in incurs memory copies rather than access to a secondary storage device, decreasing access times. Additional benefits may be further gained from collaboration as described next.

### Additional Benefits Gained From Collaboration

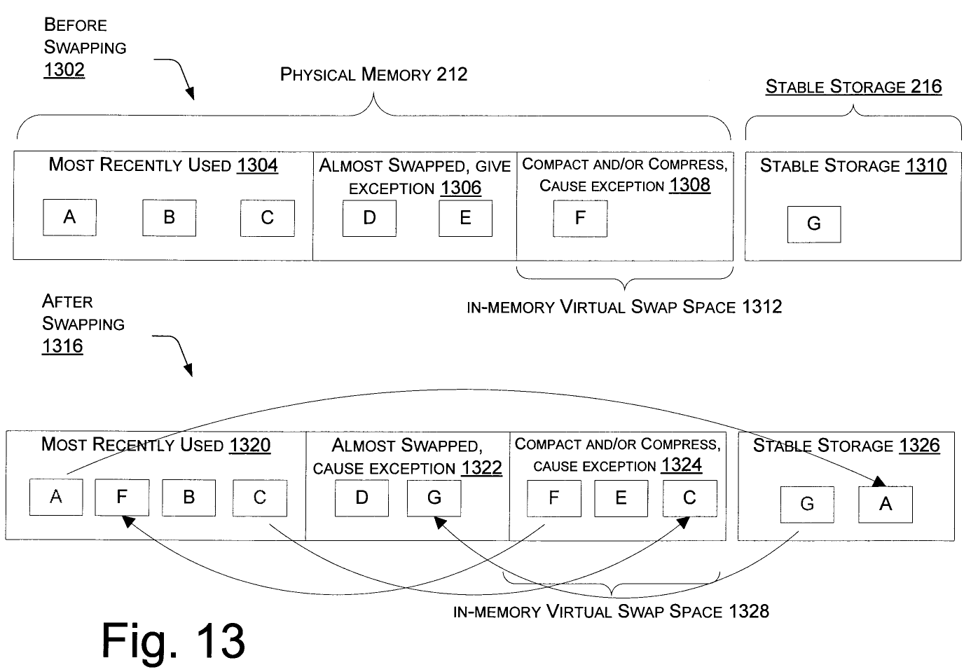

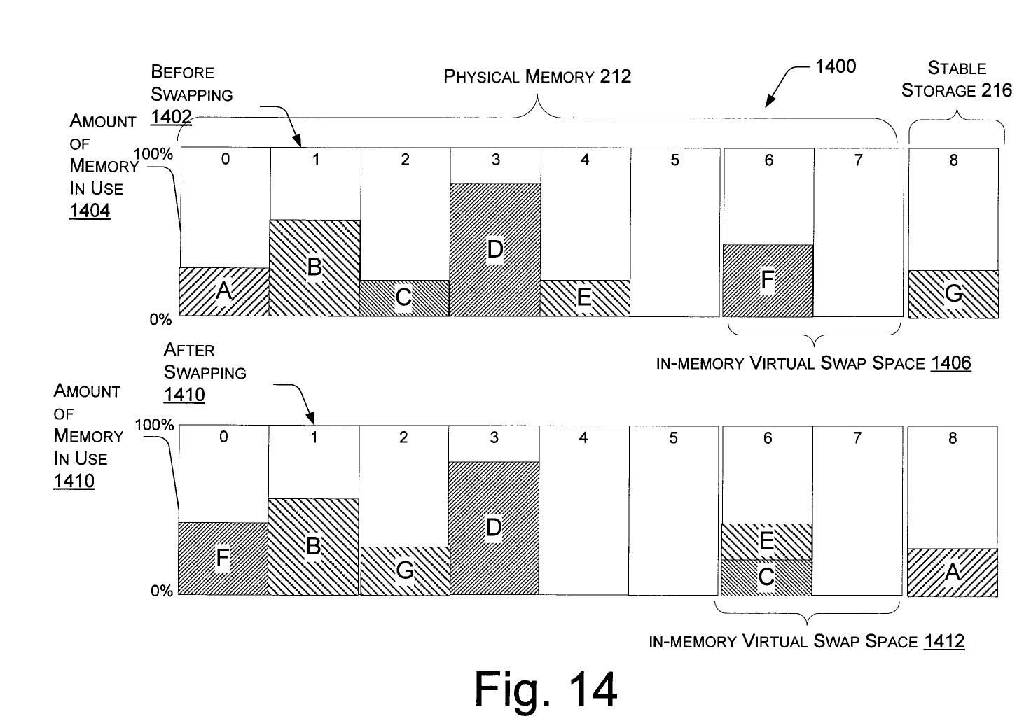

FIG. 13 illustrates the use of virtual memory by the collaboration engine using data gained from applications to adjust paging. The initial state (before swapping) has live objects A-G in various locations 1302. Live objects A-C start in the Most Recently Used category 1304, held in physical memory for quick access. Live objects D and E are Almost Swapped, and if accessed will cause an exception 1306, but still reside in physical memory. Live object F has been compacted or compressed (or both) and is stored in the in-memory virtual swap space 1312, and if accessed will cause an exception 1308. Live object G is in stable storage 1310.

Suppose that via the collaboration module, the paging module 210 in FIG. 2 consults the memory manager 102 which gains information from the application 218A. Application 218A reports that live object F will be used next, live object C will not be used for a medium length of time, live object A will not be used for a very long time, and live object G may be accessed soon. No information is provided about objects B, D, and E.

After swapping based on this information through the collaboration engine, the memory is now in a more optimal state for the next round of operations 1316. Live objects F and B are now in the Most Recently Used location 1320 and ready for immediate use. Live objects D and G are available in the Almost Swapped, Cause Exception 1322 location, and may move up to Most Recently Used 1320 or down to Compact and/or Compress Cause Exception 1324 depending on what happens later. Live objects E and C are stored in Compact and/or Compress Cause Exception 1324, and are more quickly accessible than if in stable storage 1326. Live object A has been moved directly to stable storage 1326. Because of the information available in the collaboration engine, rather than moving down through the location categories, each object is moved in one step to a better location category according to expectations. For example, live object A would have normally taken many steps to iterate down through the Most Recently Used 1320, then into Almost Swapped 1322, possibly to Compact and/or Compress 1324, then eventually to Stable Storage 1326. Using the method in this application, the movement takes only one step.

Not only does use of the collaboration engine provide the potential to move live objects into more appropriate, faster memory locations based on demand, it can free up space as illustrated next.

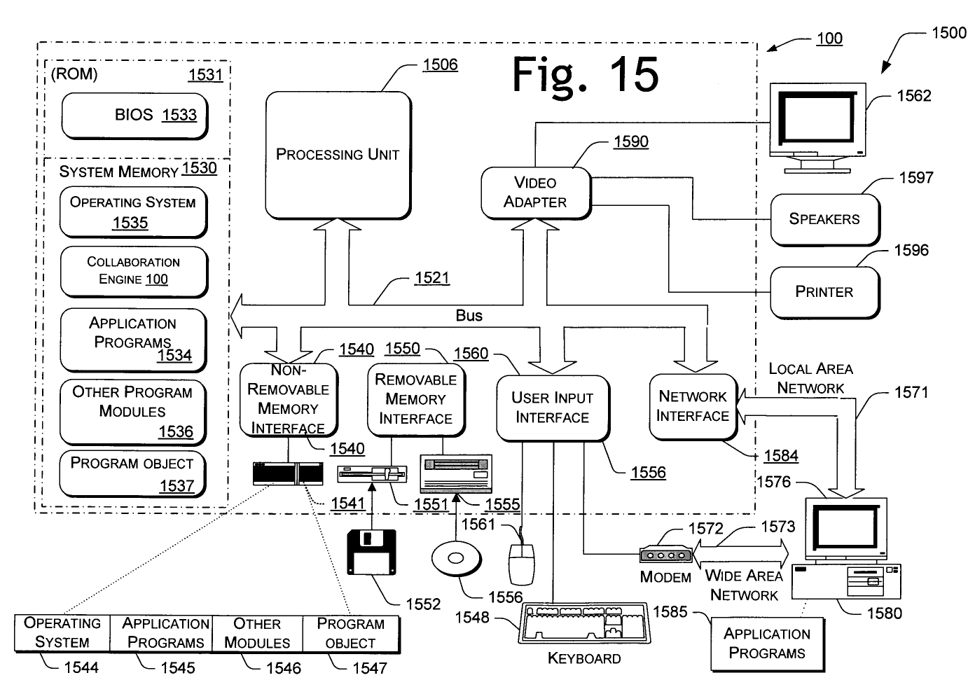

FIG. 14 is a diagram of the movement of the live objects in virtual memory pages shown in FIG. 13. Live objects A-G are presented before swapping 1402. The amount of memory in use is depicted by the relative height of the bars 1404. In-memory swap space is shown 1406, as is stable storage 216. Before swapping, only pages 5 and 7 are unused in physical memory 212.

After swapping 1410 the pages are distributed as discussed above with regard to FIG. 13. Now memory pages 4, 5 and 7 are unused, a net gain of one unused page.

A possible additional optimization method, appropriate for systems employing stable storage 216 for swapped-out pages (i.e., objects G and A which were stored in stable storage 1310 and 1326, respectively), is to allow swapping out of the pages that hold the compacted (and possibly compressed) objects to stable storage 216. Where the object in the swapped out pages is not used for a while, there is no need to keep the compacted (and possibly compressed) objects in memory. When a memory access initiates a page fault, the handler looks for the compacted (and possibly compressed) object. If that object is swapped out, then the compacted object (and possibly compressed) is first paged-in, and only then is it un-compacted and decompressed (as necessary).

### Exemplary Computing Device

FIG. 15 shows an exemplary computing system 1500 suitable as an environment for practicing aspects of the subject matter, for example to host an exemplary collaboration engine 100. The components of computing system 1500 may include, but are not limited to, a processing unit 1506, a system memory 1530, and a system bus 1521 that couples various system components including the system memory 1530 and the processing unit 1506. The system bus 1521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as the Mezzanine bus, Serial Advanced Technology Attachment (SATA), PCI Express, Hypertransport™, and Infiniband.

Exemplary computing system 1500 typically includes a variety of computing device-readable media. Computing device-readable media can be any available media that can be accessed by computing system 1500 and includes both volatile and nonvolatile media, removable and non-removable media. By way of example, and not limitation, computing device-readable media may comprise computing device storage media and communication media. Computing device storage media include volatile and nonvolatile, removable and non-removable media implemented in any method or technology for storage of information such as computing device-readable instructions, data structures, program modules, or other data. Computing device storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1500. Communication media typically embodies computing device-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computing device readable media.

The system memory 1530 includes or is associated with computing device storage media in the form of volatile and/or nonvolatile memory such as read only memory (ROM) 1531 and random access memory (RAM). A basic input/output system 1533 (BIOS), containing the basic routines that help to transfer information between elements within computing system 1500, such as during start-up, is typically stored in ROM 1531. RAM system memory 1530 typically contains data and/or program modules that are immediately accessible to and/or presently being operated on by processing unit 1506. By way of example, and not limitation, FIG. 15 illustrates operating system 1535, application programs 1534, other program modules 1536, and program data 1537. Although the exemplary collaboration engine 100 is depicted as software in random access memory 1530, other implementations of an exemplary collaboration engine 100 can be hardware or combinations of software and hardware.

The exemplary computing system 1500 may also include other removable/non-removable, volatile/nonvolatile computing device storage media. By way of example only, FIG. 15 illustrates a hard disk drive 1541 that reads from or writes to non-removable, nonvolatile magnetic media, a magnetic disk drive 1551 that reads from or writes to a removable, nonvolatile magnetic disk 1552, and an optical disk drive 1555 that reads from or writes to a removable, nonvolatile optical disk 1556 such as a CD ROM or other optical media. Other removable/non-removable, volatile/nonvolatile computing device storage media that can be used in the exemplary operating environment include, but are not limited to, magnetic tape cassettes, flash memory cards, digital versatile disks, digital video tape, solid state RAM, solid state ROM, and the like. The hard disk drive 1541 is typically connected to the system bus 1521 through a non-removable memory interface such as interface 1540, and magnetic disk drive 1551 and optical disk drive 1555 are typically connected to the system bus 1521 by a removable memory interface such as interface 1550.

The drives and their associated computing device storage media discussed above and illustrated in FIG. 15 provide storage of computing device-readable instructions, data structures, program modules, and other data for computing system 1500. In FIG. 15, for example, hard disk drive 1541 is illustrated as storing operating system 1544, application programs 1545, other program modules 1546, and program data 1547. Note that these components can either be the same as or different from operating system 1535, application programs 1534, other program modules 1536, and program data 1537. Operating system 1544, application programs 1545, other program modules 1546, and program data 1547 are given different numbers here to illustrate that, at a minimum, they are different copies. A user may enter commands and information into the exemplary computing system 1500 through input devices such as a keyboard 1548 and pointing device 1561, commonly referred to as a mouse, trackball, or touch pad. Other input devices (not shown) may include a microphone, joystick, game pad, satellite dish, scanner, or the like. These and other input devices are often connected to the processing unit 1506 through a user input interface 1560 that is coupled to the system bus, but may be connected by other interface and bus structures, such as a parallel port, game port, or a universal serial bus (USB). A monitor 1562 or other type of display device is also connected to the system bus 1521 via an interface, such as a video interface 1590. In addition to the monitor 1562, computing devices may also include other peripheral output devices such as speakers 1597 and printer 1596, which may be connected through an output peripheral interface 1595.

The exemplary computing system 1500 may operate in a networked environment using logical connections to one or more remote computing devices, such as a remote computing device 1580. The remote computing device 1580 may be a personal computing device, a server, a router, a network PC, a peer device or other common network node, and typically includes many or all of the elements described above relative to computing system 1500, although only a memory storage device 1581 has been illustrated in FIG. 15. The logical connections depicted in FIG. 15 include a local area network (LAN) 1571 and a wide area network (WAN) 1573, but may also include other networks. Such networking environments are commonplace in offices, enterprise-wide computing device networks, intranets, and the Internet.

When used in a LAN networking environment, the exemplary computing system 1500 is connected to the LAN 1571 through a network interface or adapter 1570. When used in a WAN networking environment, the exemplary computing system 1500 typically includes a modem 1572 or other means for establishing communications over the WAN 1573, such as the Internet. The modem 1572, which may be internal or external, may be connected to the system bus 1521 via the user input interface 1560, or other appropriate mechanism. In a networked environment, program modules depicted relative to the exemplary computing system 1500, or portions thereof, may be stored in the remote memory storage device. By way of example, and not limitation, FIG. 15 illustrates remote application programs 1585 as residing on memory device 1581. It will be appreciated that the network connections shown are exemplary and other means of establishing a communications link between the computing devices may be used.

### Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computer system for managing virtual memory comprising:
a collaboration engine facilitating bidirectional communication between a memory manager and a virtual memory manager; and
a virtual memory comprising a physical memory or a physical memory and stable storage and divided into pages for storing a plurality of live objects.

2. The system of claim 1 wherein the memory manager is configured to compact, or compress, or both, the live objects using the memory manager to allow a page to be reclaimed without first saving the page contents

3. The system of claim 1 wherein the bidirectional communication includes a notification from the virtual memory manager to the memory manager that a physical memory frame will be reclaimed.

4. The system of claim 1 further comprising:
a compaction module to copy at least one of the plurality of live objects each individually smaller than an entire page to another page to form compacted live objects in a compacted page.

5. The system of claim 4 further comprising:
a runtime system module to update an application pointer to refer directly to at least one of the compacted live objects in the compacted page.

6. The system of claim 5 wherein the runtime system module may be triggered on demand by the operating system and the update to the application pointer need not complete before an application accesses the live object.

7. The system of claim 4 wherein the compaction module is in a virtual memory manager.

8. The system of claim 4 wherein the compaction module is in a memory manager.

9. The system of claim 4 wherein compacted pages and mapping information to access the compacted live objects are stored in a kernel address space.

10. The system of claim 4 wherein compacted pages are stored in a user space and mapping information to access the compacted live objects is stored in a kernel address space.

11. The system of claim 4 wherein compacted pages and mapping information to access the compacted live objects are stored in a user address space.

12. A method for managing virtual memory comprising:
establishing communication between a memory manager and a virtual memory manager to transfer object content and object state bidirectionally; and
storing live objects in virtual memory comprised of either a physical memory or a physical memory and stable storage and divided into pages for storing a plurality of live objects.

13. The method of claim 12 further comprising:
compacting or compressing or both live objects using the memory manager to allow a page to be reclaimed without first saving the page contents.

14. The method of claim 12 further comprising:
receiving at the virtual memory manager from the memory manager which pages may be evicted from physical memory without saving or restoring contents of those pages.

15. The method of claim 12 further comprising:
compacting a plurality of live objects each individually smaller than an entire page by copying at least one of the live objects onto a page with at least one other live object to form compacted live objects in a compacted page.

16. The method of claim 15 further comprising:
updating an application pointer to refer directly to at least one of the compacted live objects in the compacted page during a garbage collection.

17. The method of claim 12 further comprising:
determining how to swap live objects between virtual memory pages in a paging module by communicating with a memory allocator module to learn a size and likelihood of use of the live objects on a virtual memory page.

18. The method of claim 12 further comprising:
receiving at the virtual memory manager from the memory manager that a specified portion of a page needs to be preserved when swapping out the page.

19. The method of claim 13 further comprising:
restoring contents of a page after receiving a notification from the virtual memory manager at the memory manager.

20. The method of claim 19 further comprising:
un-compacting or decompressing data in the memory manager into the page whose contents are to be restored.

21. A computer system for managing virtual memory comprising:
a collaboration engine facilitating bidirectional communication between a memory manager and a virtual memory manager;
a virtual memory comprising a physical memory or a physical memory and stable storage and divided into pages for storing a plurality of live objects;
a compaction module to copy at least one of the plurality of live objects each individually smaller than an entire page to another page to form compacted live objects in a compacted page;
a pointer updating module to update application pointers to refer directly to at least one of the compacted live objects in the compacted page; and
a paging module for swapping virtual memory pages to stable storage.
